(19) United States
(12) Patent Application Publication
(10) Pub. No.: US 2018/0183535 A1
(43) Pub. Date: Jun. 28, 2018

(54) Optimyx

(71) Applicant: Kelvin Keith Stubblefield, II, Waynesboro, VA (US)

(72) Inventor: Kelvin Keith Stubblefield, II, Waynesboro, VA (US)

(73) Assignee: StarLyte Sound LLC

(21) Appl. No.: 15/387,656

(22) Filed: Dec. 22, 2016

(51) Int. Cl. H04H 60/04; G06F 3/16; G10H 1/00

(52) U.S. Cl. CPC H04H 60/04; G06F 3/165; G10H 2220/101; G10H 2210/155; G10H 2210/105; G10H 1/0091

(57) ABSTRACT

The present disclosure describes a process for clients in the music recording industry seeking to have audio recordings mixed to their specifications. This process involves enabling the client to designate which effects to include in their final audio mix in order to receive a finished audio track that sounds closer to the client's expectations. The client is empowered to specify exactly where audio effects should take place on a track-by-track basis. This process significantly improves the client's chances of receiving an audio mix from an engineer that meets the client's specifications, and helps the engineer create the audio mix right the first time.

### BACKGROUND OF THE INVENTION

Optimyx is a tool that allows clients in the music industry to customize their audio mix to their specifications. In general, the music producing process for an independent vocal artist is as follows:
1. The artist will either lease or purchase exclusive rights to a musical composition or instrumental.
2. The artist will then write lyrics for the musical composition that he or she purchased in step 1.
3. The artist will vocally record their lyrics on separate tracks (lead vocals, chorus, harmonics, ad libs, etc.).
4. The artist will then send all individual audio stems (the purchased instrumental track plus each recorded vocal track) to an audio engineer to have the track mixed and/or mastered. The mixing process is what brings each individual track together to sound as one synchronized song. Special effects are also added to the mix for overall enhancement.
5. Once the processing is complete, the artist will receive his or her finished song.

The gap in this process lies within steps 4 and 5. When a client, or an independent artist in many cases, sends his or her audio stems to an engineer to be processed, the artist generally has a strong idea of how he or she wants their finished song to sound. The problem is conveying this information to the engineer or the person who takes on the task of mixing the track.

Currently, when an artist sends the audio stems out for processing, he or she will most likely send the individual audio stems to an engineer, ask to have it mixed, and just hope for the best. In some cases, the client may attempt to express how they want the finished song to sound. However, this can be a difficult task for the artist to convey, and for the engineer to interpret, since many artists are not familiar with the equipment and/or software plugins that audio engineers use to create the effects for enhanced audio. In addition to this, it is typical for the client to send up to 32 individual stems to be mixed. The more tracks that need to be mixed, the more processing that will need to occur for the song, and the more difficult it will be for the engineer to interpret exactly what the artist wants for each track. As a result of this, clients will often receive a final mix that sounds different from what was expected. This results in the artist contacting the engineer to correct any effects that the artist does not approve of. Ultimately, this can result in the engineer continuously reworking an audio mix until the customer is satisfied. This can hinder customer loyalty in the long run, and lengthen the backlog of projects waiting to be processed.

### SUMMARY OF THE INVENTION

Optimyx is a process created to bridge the gap between clients in the music industry and audio engineers by providing a streamlined process for clients to specify exactly how they desire each of their audio tracks to sound. Optimyx is an online tool that gives clients the freedom to upload each individual audio stem (audio track), choose which effects they want on each track, and designate the exact location of their chosen effects on each track. Clients can designate the locations of effects on each track by either specifying the time duration that each effect should take place or by specifying the words spoken or sang by the vocalist. Optimyx addresses a prevalent problem in the music industry, especially in situations in which the client is an independent vocalist.

### BRIEF DESCRIPTION OF THE SEVERAL VIEWS OF THE DRAWINGS

FIG. 1 shows the Optimyx welcome screen.

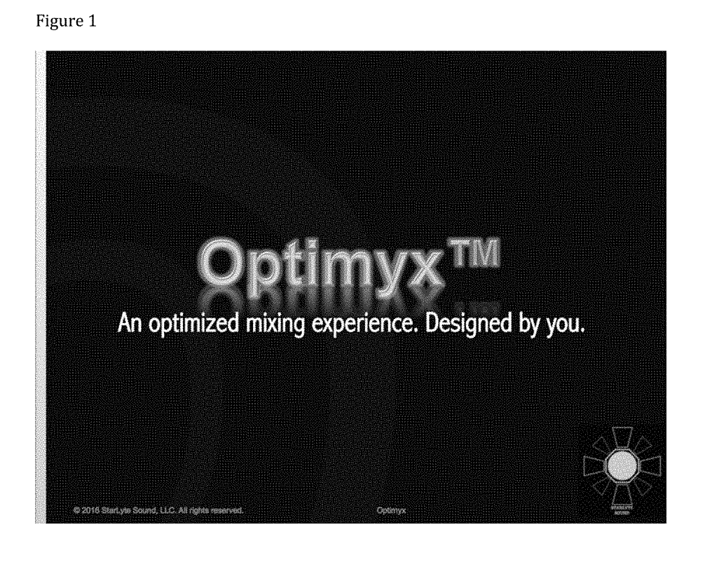

FIG. 2 represents the upper portion of the Optimyx user interface. The user can upload and customize the effects of up to 32 tracks.

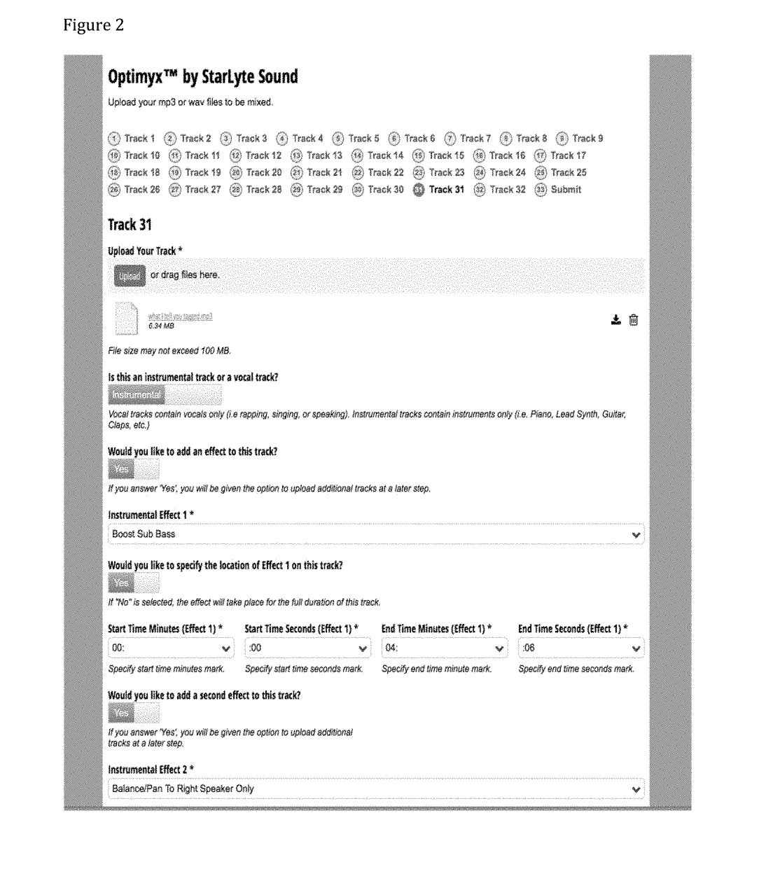

FIG. 3 represents the bottom portion of the Optimyx user interface. The user can upload and customize the effects of up to 32 audio tracks.

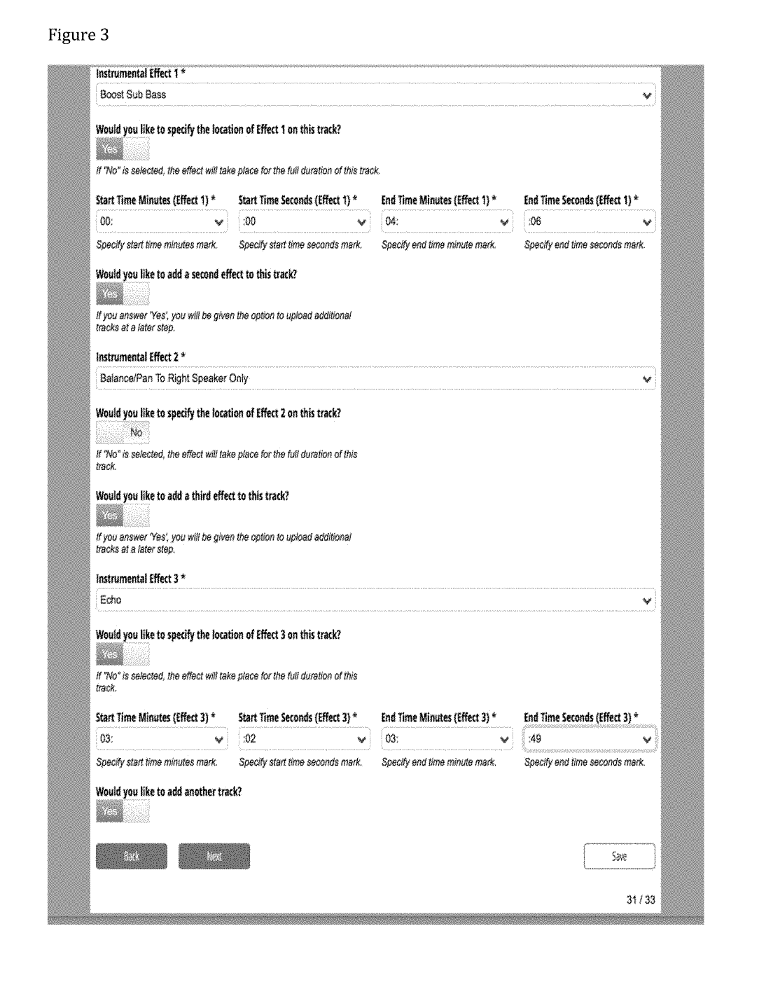

FIG. 4 shows the Optimyx Effects Library. Users can listen to examples of each available effect to aid them in choosing effects for their audio mix.

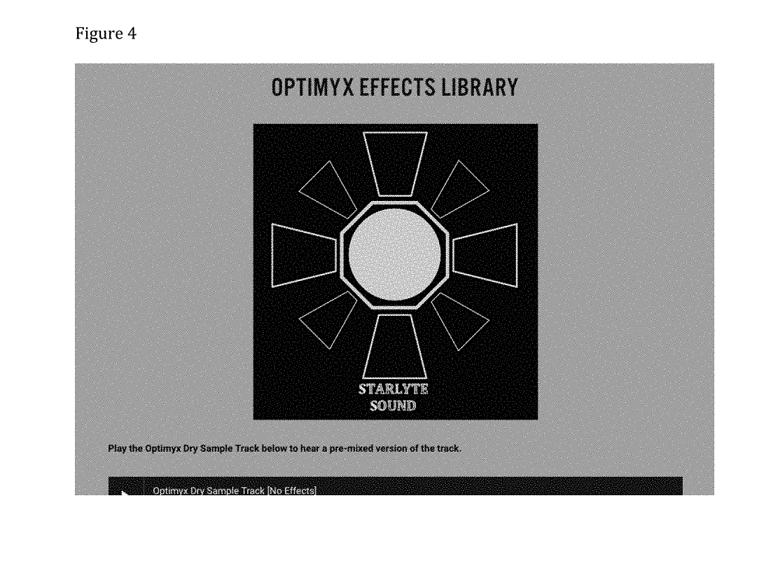

FIG. 5 shows the Optimyx Effects Library. Users can listen to examples of each available effect to aid them in choosing effects for their audio mix.

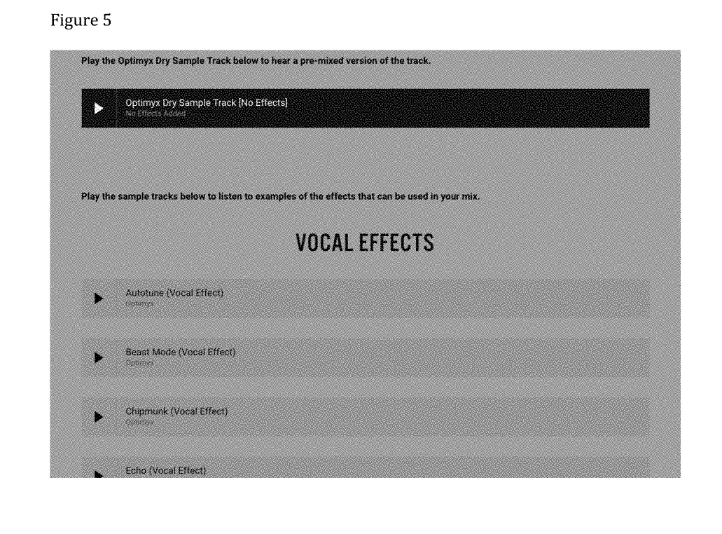

FIG. 6 shows additional vocal effects tracks in the Optimyx Effects Library.

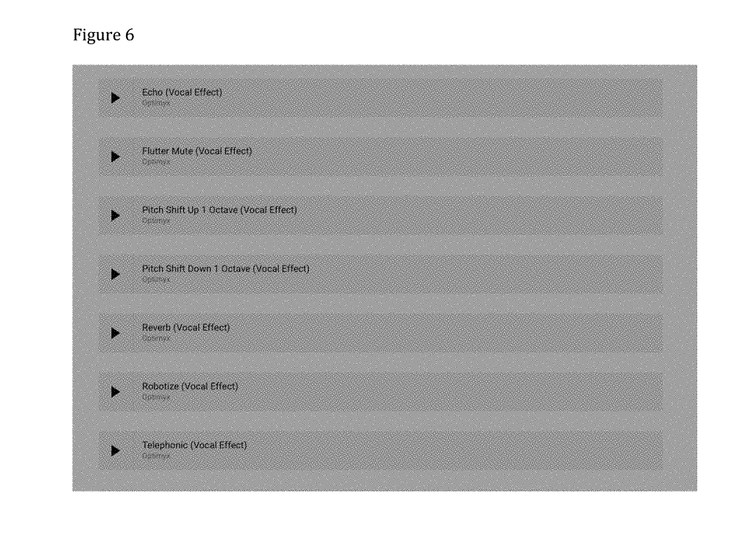

FIG. 7 shows the instrumental effects tracks in the Optimyx Effects Library.

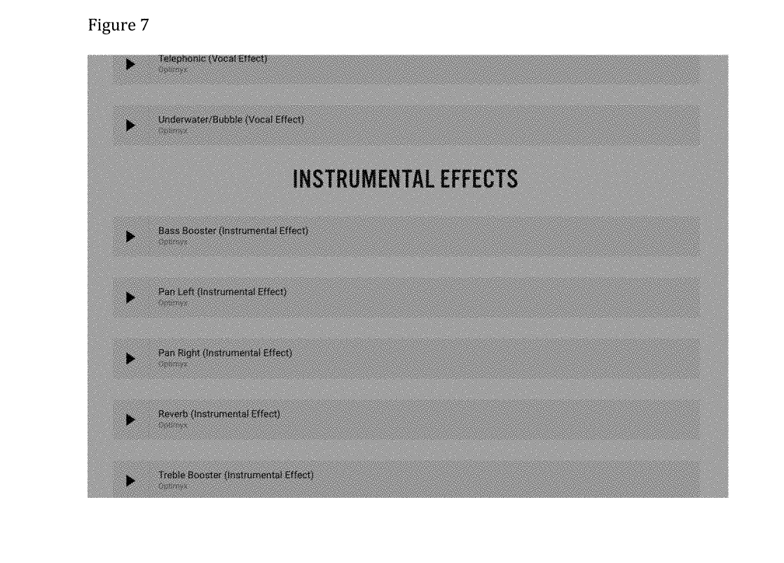

FIG. 8 shows the track-uploading step. The user will start by uploading their first track to be mixed. The user will need to click the “Upload” button and choose an audio file to upload.

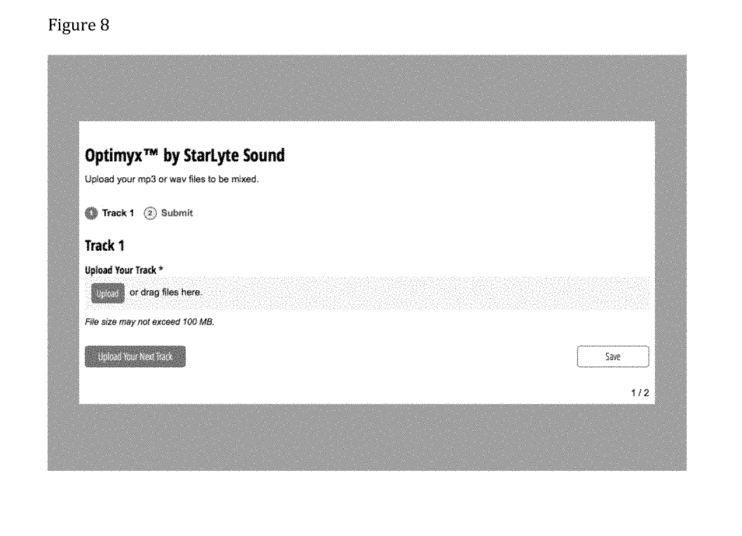

FIG. 9 shows the step in which the user is prompted to identify the uploaded track as either an instrumental track or a vocal track. The user will then choose whether or not to add an effect to this track.

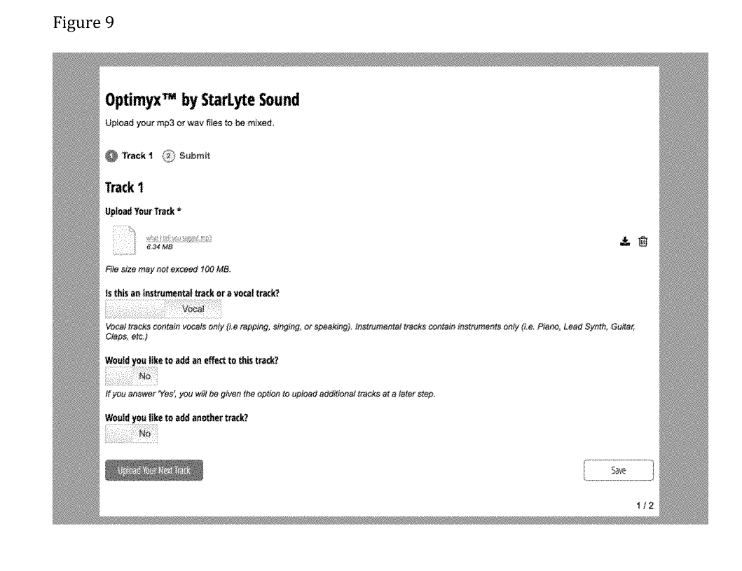

FIG. 10 shows the step in which the user will choose the desired effect from the drop down list of effects. The available effects differ depending on whether the user identified the corresponding track as an instrumental track or a vocal track.

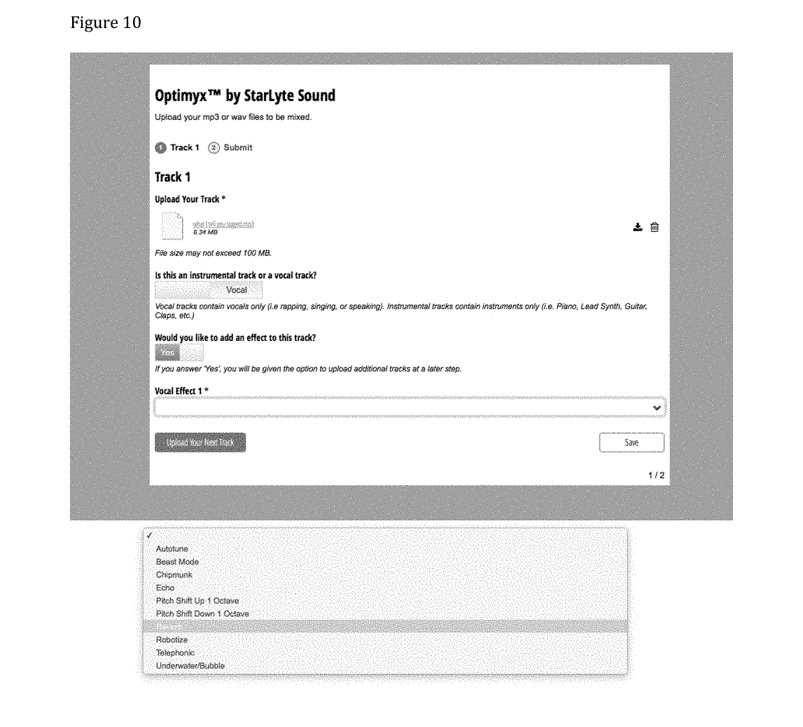

FIG. 11 shows the step in which the user will have the option to designate the exact location of the effect. The user can do this by either specifying the time frame during which the chosen effect should take place, or by specifying the wording in the lyrics (for vocal tracks) during which the effect should take place on the given track.

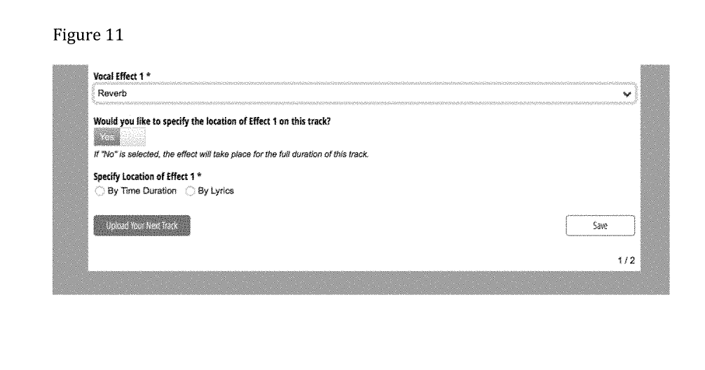

FIG. 12 shows the step in which the user chooses to specify the location by time duration. In this step, the user will be prompted to input the start and stop times, in minutes and seconds, to specify where the effect should take place on the track. In the Start Time Minutes dropdown, the user will choose the minute mark at which the effect will begin. In the Start Time Seconds dropdown the user will choose the seconds mark at which the effect will begin. In the End Time Minutes dropdown, the user will choose the minute mark at which the chosen effect will end. In the End Time Seconds dropdown, the user will choose the second mark at which the chosen effect will end. So in the example in this figure, the effect chosen by the user for this particular track will start at 2 minutes and 9 seconds and end at 3 minutes and 25 seconds.

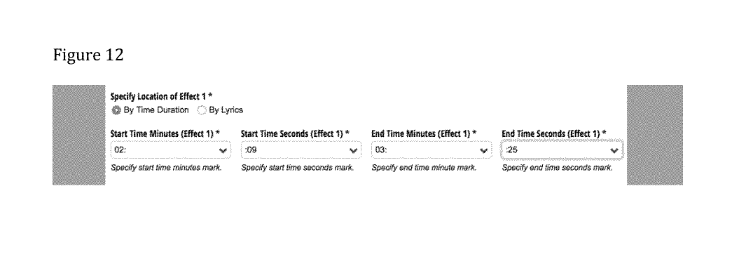

FIG. 13 shows the step in which the user chooses to specify the location of the effect by lyrics, he or she will be prompted to input the actual word(s) or phrase(s) during which the effect should take place on the track. In the example in this figure, the chosen effect will take place when the vocalist sings “Momma look how far we've come out the slums, I played by the rules so I pray to God they approve.”

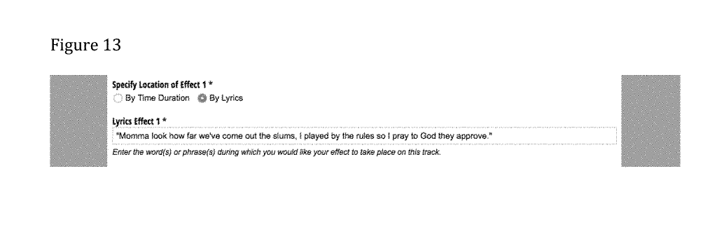

FIG. 14 shows the step in which the user will have the option to add a second effect to the uploaded track. Should the user choose to add a second effect to the track, he or she will then be prompted through steps 2 through 4 for this effect. The user will have the option to add up to the three effects per uploaded track.

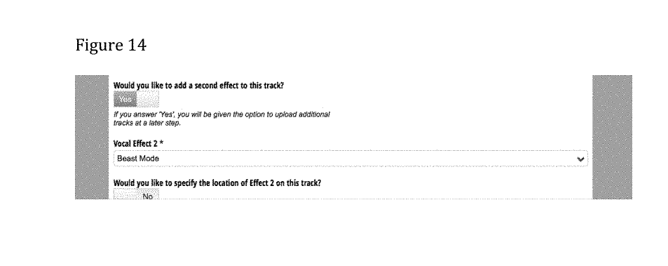

FIG. 15 shows the track-uploading step for the second track. Once all desired effects have been added to the first uploaded track, the user will then be prompted to upload the next track and follow the same process. Optimyx allows the user to upload up to thirty-two (32) tracks and specify up to three (3) effects per track.

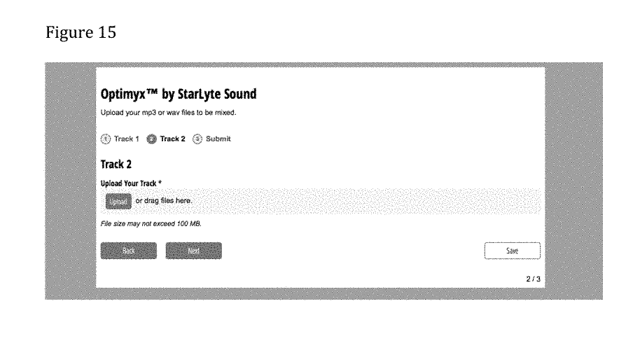

FIG. 16 shows the pop-up window that displays when the user clicks the “Save” button in the lower right-hand corner of the Optimyx window. If a user chooses to save their progress, he or she will be prompted to provide an email address.

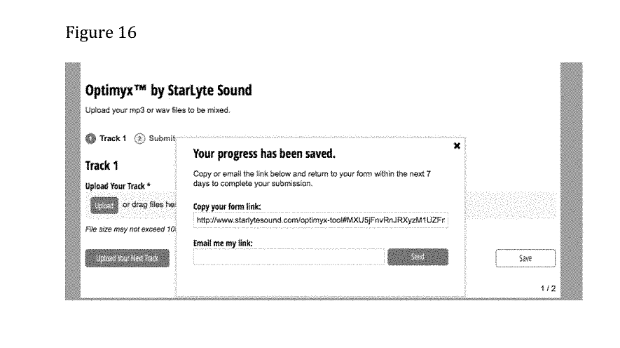

FIG. 17 shows the pop-up window that displays after the user saves their progress. A link will be sent to this email that allows the user to return to their session to complete the Optimyx process. Clicking the “Resume Now” button will take the user back to their Optimyx session.

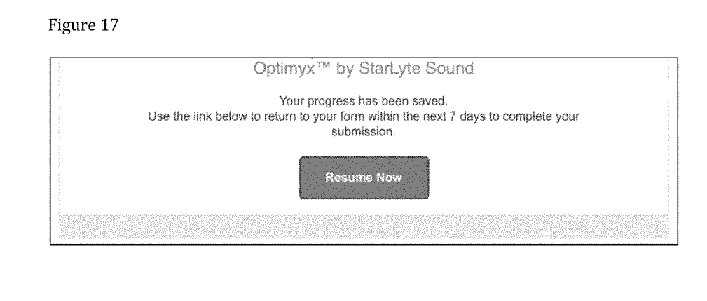

FIG. 18 shows the “Submit Payment” screen. Once the user has finished uploading all tracks and specifying all effects, the user is ready to submit their Optimyx request. When the “Next” button is clicked while the answer to the question “Would you like to upload another track” is “No”, the user will be prompted to enter their payment information. Optimyx will accept both debit and credit card payments. Once all required information is entered and the user clicks the “Submit” button, the Optimyx process will be complete. The final mix will be produced based on the user's specifications and sent to the user via email.

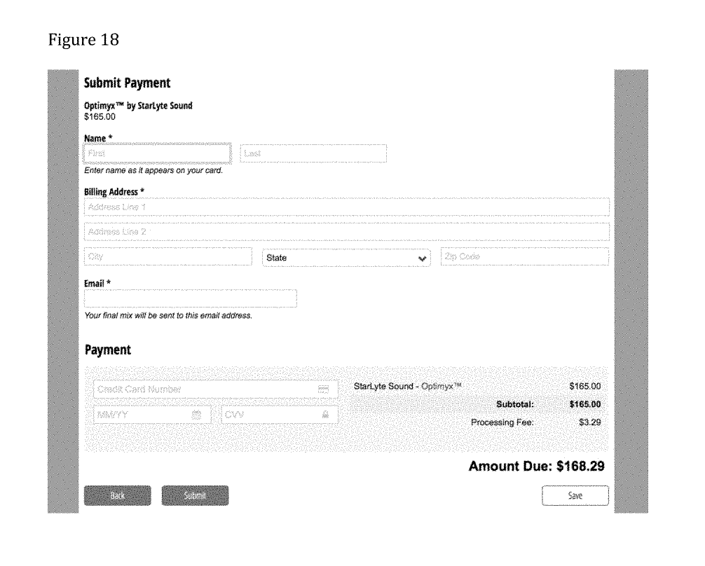

### DETAILED DESCRIPTION OF THE INVENTION

Optimyx was created using HTML-based coding language. The Optimyx process is as follows:

The user will start by uploading their first track to be mixed. The user will need to click the “Upload” button and choose an audio file to upload.

The user will be prompted to identify the uploaded track as either an instrumental track or a vocal track. The user will then choose whether or not to add an effect to this track.

The user will choose the desired effect from the drop down list of effects. The available effects differ depending on whether the user identified the corresponding track as an instrumental track or a vocal track.

The user will have the option to designate the exact location of the effect. The user can do this by either specifying the time frame during which the chosen effect should take place, or by specifying the wording in the lyrics (for vocal tracks) during which the effect should take place on the given track.

If the user chooses to specify the location by time duration, he or she will be prompted to input the start and stop times, in minutes and seconds, to specify where the effect should take place on the track. In the Start Time Minutes dropdown, the user will choose the minute mark at which the effect will begin. In the Start Time Seconds dropdown the user will choose the seconds mark at which the effect will begin. In the End Time Minutes dropdown, the user will choose the minute mark at which the chosen effect will end. In the End Time Seconds dropdown, the user will choose the second mark at which the chosen effect will end. So in the example below, the effect chosen by the user for this particular track will start at 2 minutes and 9 seconds and end at 3 minutes and 25 seconds.

If the user chooses to specify the location of the effect by lyrics, he or she will be prompted to input the actual word(s) or phrase(s) during which the effect should take place on the track. In the example below the chosen effect will take place when the vocalist sings “Momma look how far we've come out the slums, I played by the rules so I pray to God they approve.”

The user will now have the option to add a second effect to the uploaded track. Should the user choose to add a second effect to the track, he or she will then be prompted through steps 2 through 4 for this effect. The user will have the option to add up to the three effects per uploaded track.

Once all desired effects have been added to the first uploaded track, the user will then be prompted to upload the next track and follow the same process. Optimyx allows the user to upload up to thirty-two (32) tracks and specify up to three (3) effects per track.

Users can save their progress by clicking on the “Save” button located at the bottom right hand corner of the Optimyx window. If a user chooses to save their progress, he or she will be prompted to provide an email address.

A link will be sent to this email that allows the user to return to their session to complete the Optimyx process. Clicking the “Resume Now” button will take the user back to their Optimyx session.

Once the user has finished uploading all tracks and specifying all effects, the user is ready to submit their Optimyx request. When the “Next” button is clicked while the answer to the question “Would you like to upload another track” is “No”, the user will be prompted to enter their payment information. Optimyx will accept both debit and credit card payments. Once all required information is entered and the user clicks the “Submit” button, the Optimyx process will be complete. The final mix will be produced based on the user's specifications and sent to the user via email.

Having thus described the invention, I claim:

1. A process by which anyone (a “user”), whether it be an individual, group, or entity, can specify how they desire an audio track to sound by means of a web-based application, comprising of the following:
Allowing the user to customize which audio effects to integrate into an audio mix.
Allowing the user to specify desired audio effects on a track-by-track basis.
Allowing the user to specify where audio effects should take place on each uploaded audio track by specifying the time frame during which the effect should take place.
Allowing the user to specify where audio effects should take place on each uploaded audio track by specifying the words in the lyrics during which the effect should take place.
